(19) United States
(12) Patent Application Publication
(10) Pub. No.: US 2007/0160521 A1
(43) Pub. Date: Jul. 12, 2007

(54) Use of core/shell particles

(75) Inventors: Holger Winkler, Darmstadt (DE); Goetz Peter Hellmann, Mainz (DE); Tilmann Eberhard Ruhl, Griesheim (DE); Peter Spahn, Hanau (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GMBH, Darmstadt (DE)

(21) Appl. No.: 10/582,494

(22) PCT Filed: Nov. 10, 2004
(86) PCT No.: PCT/EP04/12677

§ 371 Date: Jun. 9, 2006

(30) Foreign Application Priority Data
Dec. 10, 2003 (DE) 103 57 681.9

(51) Int. Cl. B29C 67/20; C01B 31/02

(52) U.S. Cl. 423/445 R; 264/29.1; 264/49; 264/413

(57) ABSTRACT

The invention relates to the use of core/shell particles, the core of which essentially comprises a degradable polymer with an essentially mono-disperse size distribution and the shell of which forms a matrix, which can be pyrolysed to give a carbon matrix, for the production of shaped bodies with regularly-arranged cavities and the corresponding shaped bodies.

The invention relates to the use of core/shell particles for the production of mouldings having regularly arranged cavities, to a process for the production of mouldings having regularly arranged cavities, and to the corresponding mouldings.

For the purposes of the present invention, mouldings having regularly arranged cavities are materials which have three-dimensional photonic structures. The term three-dimensional photonic structures is generally taken to mean systems which have a regular, three-dimensional modulation of the dielectric constants (and thus also of the refractive index). If the periodic modulation length corresponds approximately to the wavelength of (visible) light, the structure interacts with the light in the manner of a three-dimensional diffraction grating, which is evident from angle-dependent colour phenomena. An example of this is the naturally occurring precious stone opal, which consists of silicon dioxide spheres in spherical closest packing with air- or water-filled cavities in between. The inverse structure thereto is notionally formed by regular spherical cavities being arranged in closest packing in a solid material. An advantage of inverse structures of this type over the normal structures is the formation of photonic band gaps with much lower dielectric constant contrasts still (K. Busch et al. Phys. Rev. Letters E, 198, 50, 3896).

Three-dimensional inverse structures can be produced by template synthesis:
Monodisperse spheres are arranged in spherical closest packing as structure-forming templates.
The cavities between the spheres are filled with a gaseous or liquid precursor or a solution of a precursor utilising capillary effects.
The precursor is converted (thermally) into the desired material.
The templates are removed, leaving behind the inverse structure.

Many such processes are disclosed in the literature. For example, SiO₂ spheres can be arranged in closest packing and the cavities filled with tetraethyl orthotitanate-containing solutions. After a number of conditioning steps, the spheres are removed using HF in an etching process, leaving behind the inverse structure of titanium dioxide (V. Colvin et al. Adv. Mater. 2001, 13, 180).

De La Rue et al. (De La Rue et al. Synth. Metals, 2001, 116, 469) describe the production of inverse opals consisting of TiO₂ by the following method: a dispersion of 400 nm polystyrene spheres is dried on a filter paper under an IR lamp. The filter cake is washed by sucking through ethanol, transferred into a glove box and infiltrated with tetraethyl orthotitanate by means of a water-jet pump. The filter paper is carefully removed from the latex/ethoxide composite, and the composite is transferred into a tubular furnace. Calcination in a stream of air is carried out in the tubular furnace at 575° C. for 8 hours, causing the formation of titanium dioxide from the ethoxide and burning out the latex particles. An inverse opal structure of TiO₂ is left behind.

Martinelli et al. (M. Martinelli et al. Optical Mater. 2001, 17, 11) describe the production of inverse TiO₂ opals using 780 nm and 3190 nm polystyrene spheres. A regular arrangement in spherical closest packing is achieved by centrifuging the aqueous sphere dispersion at 700-1000 rpm for 24-48 hours followed by decantation and drying in air. The regularly arranged spheres are moistened with ethanol on a filter in a Büchner funnel and then provided dropwise with an ethanolic solution of tetraethyl orthotitanate. After the titanate solution has percolated in, the sample is dried in a vacuum desiccator for 4-12 hours. This filling procedure is repeated 4 to 5 times. The polystyrene spheres are subsequently burnt out at 600° C.-800° C. for 8-10 hours.

Stein et al. (A. Stein et al. Science, 1998, 281, 538) describe the synthesis of inverse TiO₂ opals starting from polystyrene spheres having a diameter of 470 nm as templates. These are produced in a 28-hour process, subjected to centrifugation and air-dried. The latex templates are then applied to a filter paper. Ethanol is sucked into the latex template via a Büchner funnel connected to a vacuum pump. Tetraethyl orthotitanate is then added dropwise with suction. After drying in a vacuum desiccator for 24 hours, the latices are burnt out at 575° C. for 12 hours in a stream of air.

Vos et al. (W. L. Vos et al. Science, 1998, 281, 802) produce inverse TiO₂ opals using polystyrene spheres having diameters of 180-1460 nm as templates. In order to establish spherical closest packing of the spheres, a sedimentation technique is used supported by centrifugation over a period of up to 48 hours. After slow evacuation in order to dry the template structure, an ethanolic solution of tetra-n-propoxy orthotitanate is added to the latter in a glove box. After about 1 hour, the infiltrated material is brought into the air in order to allow the precursor to react to give TiO₂. This procedure is repeated eight times in order to ensure complete filling with TiO₂. The material is then calcined at 450° C.

Core/shell particles whose shell forms a matrix and whose core is essentially solid and has an essentially monodisperse size distribution are described in German patent application DE-A-10145450. The use of core/shell particles whose shell forms a matrix and whose core is essentially solid and has an essentially monodisperse size distribution as templates for the production of inverse opal structures and a process for the production of inverse opal-like structures using core/shell particles of this type are described in the earlier German patent application DE 10245848.0. The mouldings described having regularly arranged cavities (i.e. inverse opal structure) preferably have walls of metal oxides or of elastomers. Consequently, the mouldings described are either hard and brittle or exhibit an elastomeric character with low mechanical loadability.

The earlier German patent application DE 10341198.4 describes mouldings whose mechanical properties are particularly advantageous. Core/shell particles whose shell forms a matrix and whose core is essentially solid and has an essentially monodisperse size distribution and is bonded to the core via an interlayer and the shell has thermoplastic properties are used here for the production of mouldings having regularly arranged cavities.

Surprisingly, it has now been found that it is possible to obtain mouldings having regularly arranged cavities and having a carbon matrix if suitable core/shell particles are used as templates in the production.

The present invention therefore relates firstly to the use of core/shell particles whose shell forms a matrix and whose core essentially consists of a degradable polymer and has an essentially monodisperse size distribution and whose shell can be pyrolysed to give a carbon matrix, for the production of mouldings having regularly arranged cavities.

The term carbon matrix here is taken to mean materials which substantially correspond to those of carbon fibres. In an extreme case, the carbon matrix according to the invention is elemental carbon, preferably in amorphous or partially crystalline form, where the crystalline fractions are in the graphite modification or graphite-like modifications, such as fullerenes, carbon nanotubes and similar graphite-like structures. In another extreme variant of the present invention, the carbon matrix comprises conductor polymers, such as, for example, polyimides, which form on thermal condensation of polyacrylonitrile. In general, however, the carbon matrix is a material whose chemical structure lies between these two extremes. It is assumed that, in a similar manner to the situation in carbon blacks, varying proportions of polycyclic aromatic hydrocarbons provided with imidic functions can be present in the materials.

In order to simplify the formation of the carbon matrix, it is particularly preferred in accordance with the invention for the shell in the core/shell particles to consist of essentially uncrosslinked organic polymers which are grafted onto the core via an at least partially crosslinked interlayer, where the shell is preferably formed essentially from polyacrylonitrile (PAN) or polymethacrylonitrile or copolymers containing polyacrylonitrile or polymethacrylonitrile, such as polystyrene-acrylonitrile (PSAN). PAN decomposes here at temperatures as low as 250-280° C. to form a suitable carbon matrix.

The present invention furthermore relates to a process for the production of mouldings having regularly arranged cavities, characterised in that core/shell particles whose shell forms a matrix and whose core essentially consists of a degradable polymer and has an essentially monodisperse size distribution and whose shell can be pyrolysed to give a carbon matrix are converted into mouldings, preferably films, with application of a mechanical force and elevated temperature, and the cores are subsequently removed by degradation and the shell is decomposed at elevated temperature to give a carbon matrix.

It is particularly preferred in accordance with the invention for the degradable core in the core/shell particles to be thermally degradable and to consist of polymers which are either thermally depolymerisable, i.e. decompose into their monomers on exposure to heat, or for the core to consist of polymers which decompose on degradation to give low-molecular-weight constituents which are different from the monomers. It is important here that the degradation of the core polymers takes place at a temperature which is equal to or lower than the temperature at which the carbon matrix forms. Suitable polymers are given, for example, in the table “Thermal Degradation of Polymers” in Brandrup, J. (Ed.).: Polymer Handbook. Chichester Wiley 1966, pp. V-6-V-10, all polymers which give volatile degradation products being suitable. The contents of this table are expressly part of the disclosure content of the present application.

Suitable thermally degradable polymers are, in particular,
poly(styrene) and derivatives, such as poly(α-methylstyrene) or poly(styrene) derivatives carrying substituents on the aromatic ring, such as, in particular, partially or perfluorinated derivatives,
poly(acrylate) and poly(methacrylate) derivatives as well as esters thereof, particularly preferably poly(methyl methacrylate) or poly(cyclohexyl methacrylate), or copolymers of these polymers with other degradable polymers, such as, preferably, styrene-ethyl acrylate copolymers or methyl methacrylate-ethyl acrylate copolymers,
polybutadiene and copolymers with other monomers mentioned here,
cellulose and derivatives, such as oxidated cellulose and cellulose triacetate,
polyketones, such as, for example, poly(methyl isopropenyl ketone) or poly(methyl vinyl ketone),
polyolefins, such as, for example, polyethylene and polypropylene, polylsisoprene, polyolefin oxides, such as, for example, polyethylene oxide or polypropylene oxide, polyethylene terephthalate, polyformaldehyde, polyamides, such as nylon 6 and nylon 66, polyperfluoroglucarodiamidine, polyperfluoropolyolefins, such as plolperfluoropropylene and plolyperfluoroheptene,
polyvinyl acetate, polyvinyl chloride, polyvinyl alcohol, polyvinylcyclohexanone, polyvinyl butyrate and polyvinyl fluoride.

Particular preference is given here to the use of poly(styrene) and derivatives, such as poly(α-methylstyrene) or poly(styrene) derivatives carrying substituents on the aromatic ring, such as, in particular, partially or perfluorinated derivatives, poly(acrylate) and poly(methacrylate) derivatives as well as esters thereof, particularly preferably poly(methyl methacrylate) or poly(cyclohexyl methacrylate), or copolymers of these polymers with other degradable polymers, such as, preferably, styrene-ethyl acrylate copolymers or methyl methacrylate-ethyl acrylate copolymers, and polyolefins, polyolefin oxides, polyethylene terephthalate, polyformaldehyde, polyamides, polyvinyl acetate, polyvinyl chloride or polyvinyl alcohol.

In another, likewise preferred embodiment of the present invention, the core consists of polymers which can be degraded by UV radiation. Particular mention should be made here of poly(tert-butyl methacrylate), poly(methyl methacrylate), poly(n-butyl methacrylate) and copolymers containing one of these polymers.

Other mouldings having regularly arranged cavities which are embedded in a carbon matrix are described in A. A. Zakhidov, R. H. Baughman, Z. lqbal, C. Cui, I. Khayrullin, S. O. Dantas, J. Marti, V. G. Ralchenko, Science 282 (1998) 897-901. Particles having an amorphous carbon matrix are obtained by firstly ordering SiO₂ spheres to give an opal structure, and impregnating these with a phenolic resin for 2 days. The resin is subsequently cured for 7 days, the impregnated opal is separated mechanically from the surrounding resin, the SiO₂ is removed by HF etching, and the matrix is subsequently fired at 900° C. to give carbon.

M. W. Perpall, K. Prasanna, U. Perera, J. DiMaio, J. Ballato, St. H. Foulger, D. W. Smith, Langmuir 2003, 19, 7153-7156 describe a method for the preparation of inverse pale from glass-like carbon. To this end, an opal structure is produced from silica particles, and this is crosslinked by sintering. The opal pores are subsequently impregnated with bis(orthodivinylbenzene) monomers, these are cured fully, the SiO₂ is removed by HF etching, and the matrix is subsequently fired to give carbon.

The use according to the invention of core/shell particles in the production of mouldings having cavities results, in particular, in the following advantages:
large-area regions of high order can be obtained in the template, it being possible, in particular, to ensure uniform orientation of the (111) lattice plane parallel to the moulding surface,
the associated process can be carried out on a large industrial scale, if necessary also continuously,
the associated process can be carried out economically owing to the possible production speed and the low energy costs compared with similar known processes,
the shell polymers can interloop with one another and thus mechanically stabilise the regular spherical arrangement in the template,
since the shell is strongly bonded—preferably by grafting—to the core via an interlayer, the templates can be processed by melt processes,
the resultant mouldings are distinguished by high mechanical strength, in particular tensile strength,
the resultant mouldings are distinguished by high heat resistance,
the resultant mouldings are distinguished by electrical conductivity,
the resultant mouldings can be used without additional supports owing to their mechanical stability,
resultant mouldings having ellipsoidal pores can be produced deliberately and employed as photonic material, in particular for utilisation of anisotropic effects.

The present invention therefore furthermore also relates to the products obtainable by the use according to the invention. Mouldings having regularly arranged cavities which are embedded in a carbon matrix, which are characterised in that they are obtainable by the process according to the invention, are therefore also claimed.

In order to achieve the optical or photonic effect according to the invention, it is desirable for the core/shell particles to have a mean particle diameter in the range from about 5 nm to about 2000 nm. It may be particularly preferred here for the core/shell particles to have a mean particle diameter in the range from about 5 to 20 nm, preferably from 5 to 10 nm. In this case, the cores may be known as “quantum dots”; they exhibit the corresponding effects known from the literature. In order to achieve colour effects in the region of visible light, it is particularly advantageous for the core/shell particles to have a mean particle diameter in the range about 50-800 nm. Particular preference is given to the use of particles in the range 100-600 nm and very particularly preferably in the range from 200 to 450 nm since, in particles in this size range (depending on the refractive-index contrast which can be achieved in the photonic structure), the reflections of various wavelengths of visible light differ significantly from one another, and thus the opalescence which is particularly important for optical effects in the visible region occurs to a particularly pronounced extent in a very wide variety of colours. However, it is also preferred in a variant of the present invention to employ multiples of this preferred particle size, which then result in reflections corresponding to the higher orders and thus in a broad colour play.

The cavities of the mouldings according to the invention then in each case have corresponding mean diameters which are approximately identical to the diameters of the cores. The cavity diameter thus corresponds to about ⅔ of the core/shell particle diameter for preferred core/shell ratios of the particles. It is particularly preferred in accordance with the invention for the mean diameter of the cavities to be in the range about 50-500 nm, preferably in the range 100-500 nm and very particularly preferably in the range from 200 to 280 nm.

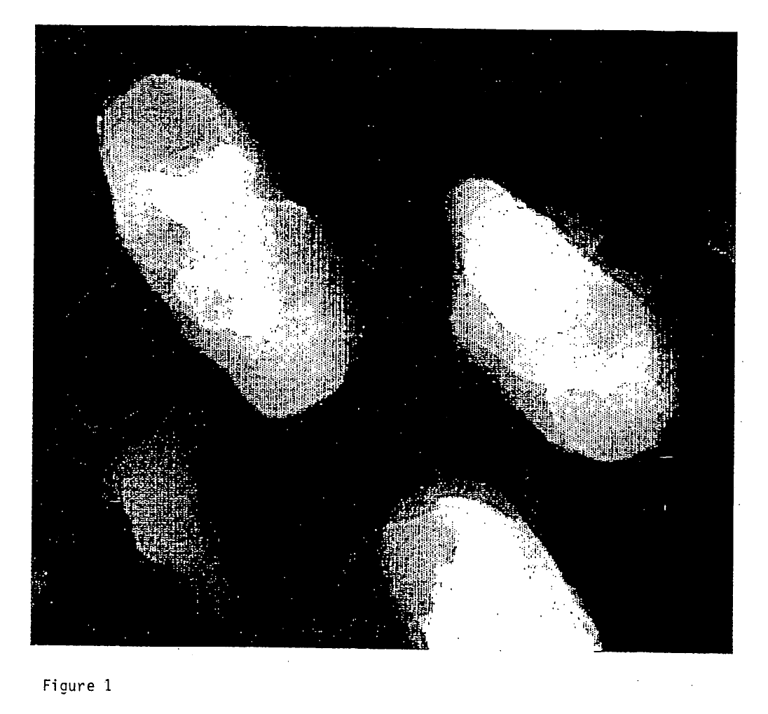

In a preferred variant of the present invention, the cavities are not spherical, but instead have an anisotropy (cf. FIG. 1). The present invention therefore furthermore relates to corresponding mouldings having directed ellipsoidal cavities. For the purposes of the present invention, ellipsoidal means that the pores have a different diameter in at least one spatial direction than in the other spatial directions and consequently are not spherical. Directed means that the spatial direction of the pores is such that the deviating diameters in different pores are aligned approximately parallel to one another.

It has been found that corresponding mouldings can be obtained particularly well if, as described above, the cores are removed in a first step, and the carbon matrix is produced in a second step taking place at a different time. Mouldings having ellipsoidal pores can also be obtained if the two steps are carried out simultaneously.

If it is intended that the pores are as spherical as possible, an appropriate production process is one in which the matrix is pre-condensed in a first step, and the cores are only removed in a second, subsequent step. For example, the template material can firstly be conditioned at a temperature below the decomposition temperature of the cores.

In a preferred embodiment of the invention, the interlayer is a layer of crosslinked or at least partially crosslinked polymers. The crosslinking of the interlayer here can take place via free radicals, for example induced by UV irradiation, or preferably via di- or oligofunctional monomers. Preferred interlayers in this embodiment comprise from 0.01 to 100% by weight, particularly preferably from 0.25 to 10% by weight, of di- or oligofunctional monomers. Preferred di- or oligofunctional monomers are, in particular, isoprene and allyl methacrylate (ALMA). Such an interlayer of crosslinked or at least partially crosslinked polymers preferably has a thickness in the range from 10 to 20 nm. If the interlayer comes out thicker, the refractive index of the layer is selected so that it corresponds either to the refractive index of the core or to the refractive index of the shell.

If copolymers which, as described above, contain a crosslinkable monomer are employed as interlayer, the person skilled in the art will have absolutely no problems in suitably selecting corresponding copolymerisable monomers. For example, corresponding copolymerisable monomers can be selected from a so-called Q-e-scheme (cf. textbooks on macro-molecular chemistry). Thus, monomers such as methyl methacrylate and methyl acrylate can preferably be polymerised with ALMA. In this case, the interlayer can be broken down together with the core.

In another, likewise preferred embodiment of the present invention, shell polymers are grafted directly onto the core via a corresponding functionalisation of the core. The surface functionalisation of the core here forms the interlayer according to the invention.

In a preferred embodiment, the shell of these core/shell particles consists of essentially uncrosslinked organic polymers, which are preferably grafted onto the core via an at least partially crosslinked interlayer. The core can consist of a very wide variety of materials. The only essential factor for the purposes of the present invention is that the cores can be removed under conditions under which the wall material is stable or carbonisable. The choice of suitable core/shell/interlayer/wall material combinations presents the person skilled in the art with absolutely no difficulties.

It is furthermore preferred in accordance with the invention for the core of the core/shell particles to consist of a material which is either not flowable or becomes flowable at a temperature above the melting point of the shell material. This can be achieved through the use of polymeric materials having a correspondingly high glass transition temperature (T_{g}), preferably crosslinked polymers.

The wall of the moulding having regularly arranged cavities is formed from the carbon matrix described above.

In the process according to the invention for the production of a moulding having regularly arranged cavities, a “positive” opal structure is formed as template in a first step through the application of a mechanical force to the core/shell particles.

For the purposes of the present invention, the action of mechanical force can be the action of a force which occurs in the conventional processing steps of polymers. In preferred variants of the present invention, the action of mechanical force takes place either:
through uniaxial pressing or
action of force during an injection-moulding operation or
during a transfer-moulding operation,
during (co)extrusion or
during a calendering operation or
during a blowing operation.

If the action of force takes place through uniaxial pressing, the mouldings according to the invention are preferably films. Films according to the invention can preferably also be produced by calendering, film blowing or flat-film extrusion. The various ways of processing polymers under the action of mechanical forces are well known to the person skilled in the art and are revealed, for example, by the standard textbook Adolf Franck, “Kunststoff-Kompendium” [Plastics Compendium]; Vogel-Verlag; 1996. The processing of core/shell particles through the action of mechanical force, as is preferred here, is furthermore described in detail in interna-tional patent application WO 2003025035.

In a preferred variant of the production of mouldings according to the invention, the temperature during production is at least 40° C., preferably at least 60° C., above the glass transition temperature of the shell of the core/shell particles. It has been shown empirically that the flowability of the shell in this temperature range meets the requirements for economic production of the mouldings to a particular extent.

In a likewise preferred process variant which results in mouldings according to the invention, the flowable core/shell particles are cooled under the action of the mechanical force to a temperature at which the shell is no longer flowable.

If mouldings are produced by injection moulding, it is particularly preferred for the demoulding not to take place until after the mould with the moulding inside has cooled. When carried out in industry, it is advantageous to employ moulds having a large cooling-channel cross section since the cooling can then take place in a relatively short time. It has been found that cooling in the mould makes the colour effects according to the invention much more intense. It is assumed that better ordering of the core/shell particles to form the lattice occurs in this uniform cooling operation. It is particularly advantageous here for the mould to have been heated before the injection operation.

The mouldings according to the invention may, if it is technically advantageous, comprise auxiliaries and additives here. They can serve for optimum setting of the applicational data or properties desired or necessary for application and processing. Examples of auxiliaries and/or additives of this type are antioxidants, UV stabilisers, biocides, plasticisers, film-formation auxiliaries, flow-control agents, fillers, melting assistants, adhesives, release agents, application auxiliaries, demoulding auxiliaries, viscosity modifiers, for example thickeners.

Particularly recommended are additions of film-formation auxiliaries and film modifiers based on compounds of the general formula HO—CₙH₂ₙ—O—(CₙH₂ₙ—O)ₘH, in which n is a number from 2 to 4, preferably 2 or 3, and m is a number from 0 to 500. The number n can vary within the chain, and the various chain members can be incorporated in a random or blockwise distribution. Examples of auxiliaries of this type are ethylene glycol, propylene glycol, di-, tri- and tetraethylene glycol, di-, tri- and tetrapropylene glycol, polyethylene oxides, polypropylene oxide and ethylene oxide-propylene oxide copolymers having molecular weights of up to about 15,000 and a random or block-like distribution of the ethylene oxide and propylene oxide units.

If desired, organic or inorganic solvents, dispersion media or diluents, which, for example, extend the open time of the formulation, i.e. the time available for its application to substrates, waxes or hot-melt adhesives are also possible as additives.

If desired, UV and weathering stabilisers can also be added to the mouldings. Suitable for this purpose are, for example, derivatives of 2,4-dihydroxybenzophenone, derivatives of 2-cyano-3,3′-diphenyl acrylate, derivatives of 2,2′,4,4′-tetrahydroxybenzophenone, derivatives of o-hydroxy-phenylbenzotriazole, salicylic acid esters, o-hydroxyphenyl-s-triazines or sterically hindered amines. These substances may likewise be employed individually or in the form of a mixture.

The total amount of auxiliaries and/or additives is up to 40% by weight, preferably up to 20% by weight, particularly preferably up to 5% by weight, of the weight of the mouldings.

The cores can be removed in various ways. In a process which is preferred in accordance with the invention, the cores are removed by thermal degradation with exposure to air at temperatures of at least 150° C., preferably at least 200° C. and particularly preferably at least 220° C. It may be preferred here for the monomers and oligomers formed by thermal depolymerisation to be separated off by distillation. The products of this process step may themselves already be the end products for the purposes of the present invention.

In this case, the carbon matrix can best be described as a conductor polymer-containing structure. On use of acrylonitrile-based homopolymers or copolymers, it is assumed that polyimides form, for example in accordance with the following scheme:

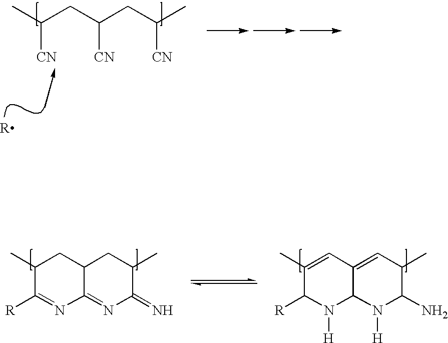

However, it may also be preferred in accordance with the invention for the carbon matrix to be produced at temperatures in the range from 700 to 1200° C., preferably in the range from 800 to 1000° C., with exclusion of air after or instead of the thermal depolymerisation with exposure to air. In this case, the resultant carbon matrix can better be described as an amorphous, partially crystalline or crystalline carbon material, in particular as a graphite-like carbon material.

The cavities of the mouldings can be impregnated with liquid or gaseous materials. The impregnation here can consist, for example, in incorporation of liquid crystals, as described, for example, in Ozaki et al., Adv. Mater. 2002, 14, 514 and Sato et al., J. Am. Chem. Soc. 2002, 124, 10950. Electro-optical polymers can also be incorporated into the cavities.

Through impregnation with these or other materials, the optical, electrical, acoustic and mechanical properties can be influenced by external energy fields. In particular, it is possible to use an external energy field to render these properties switchable in that removal of the field causes the system to exhibit different properties than in an applied field.

Thus, for example, the refractive index difference between matrix and pores filled with liquid-crystalline material changes when the liquid crystals are aligned in an electric field. The reflection or transmission of certain wavelengths thus becomes electrically switchable and can thus be utilised for optical transmission of data.

Locally addressable selection with the aid of the external field enables electro-optical devices to be produced in this way. The present invention therefore furthermore relates to the use of the mouldings according to the invention having regularly arranged cavities for the production of electro-optical devices and to electro-optical devices containing the mouldings according to the invention.

Electro-optical devices based on liquid crystals are extremely well known to the person skilled in the art and can be based on various effects. Examples of such devices are cells having dynamic scattering, DAP (deformation of aligned phases) cells, guest/host cells, TN cells having a twisted nematic structure, STN (supertwisted nematic) cells, SBE (superbirefringence effect) cells and OMI (optical mode interference) cells. The commonest display devices are based on the Schadt-Helfrich effect and have a twisted nematic structure.

The corresponding liquid-crystal materials must have good chemical and thermal stability and good stability to electric fields and electromagnetic radiation. Furthermore, the liquid-crystal materials should have low viscosity and produce short addressing times, low threshold voltages and high contrast in the cells.

They should furthermore have a suitable mesophase, for example a nematic or cholesteric mesophase for the above-mentioned cells, at the usual operating temperatures, i.e. in the broadest possible range above and below room temperature. Since liquid crystals are generally used as mixtures of a plurality of components, it is important that the components are readily miscible with one another. Further properties, such as the electrical conductivity, the dielectric anisotropy and the optical anisotropy, have to satisfy various requirements depending on the cell type and area of application. For example, materials for cells having a twisted nematic structure should have positive dielectric anisotropy and low electrical conductivity.

For example, for matrix liquid-crystal displays with integrated non-linear elements for switching individual pixels (MLC displays), media having large positive dielectric anisotropy, relatively low birefringence, broad nematic phases, very high specific resistance, good UV and temperature stability and low vapour pressure are desired.

Matrix liquid-crystal displays of this type are known. Non-linear elements which can be used for individual switching of the individual pixels are, for example, active elements (i.e. transistors). The term “active matrix” is then used, where a distinction can be made between two types:
1. MOS (metal oxide semiconductor) or other diodes on a silicon wafer as substrate.
2. Thin-film transistors (TFTs) on a glass plate as substrate.

The use of single-crystal silicon as substrate material restricts the display size, since even modular assembly of various part-displays results in problems at the joints.

In the case of the more promising type 2, which is preferred, the electro-optical effect used is usually the TN effect. A distinction is made between two technologies: TFTs comprising compound semiconductors, such as, for example, CdSe, or TFTs based on polycrystalline or amorphous silicon. Intensive work is being carried out worldwide on the latter technology.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The TFT displays usually operate as TN cells with crossed polarisers in transmission and are back-lit.

The term MLC displays here covers any matrix display with integrated non-linear elements, i.e., besides the active matrix, also displays with passive elements, such as varistors or diodes (MIM=metal-insulator-metal).

MLC displays of this type are particularly suitable for TV applications (for example pocket TVs) or for high-information displays for computer applications (laptops) and in automobile or aircraft construction. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to achieve acceptable service lives.

In the case of supertwisted (STN) cells, media are desired which enable greater multiplexability and/or lower threshold voltages and/or broader nematic phase ranges (in particular at low temperatures). To this end, a further widening of the available parameter latitude (clearing point, smectic-nematic transition or melting point, viscosity, dielectric parameters, elastic parameters) is urgently desired.

The mouldings according to the invention can in principle, on combination with liquid-crystal mixtures suitable in each case which are known to the person skilled in the art, be employed in electro-optical displays based on all principles described.

The mouldings having regularly arranged cavities obtainable in accordance with the invention are suitable firstly for the above-described use as photonic material, preferably with the impregnation mentioned, but secondly also for the production of porous surfaces, membranes, separators, filters and porous supports. These materials can also be used, for example, as barrier membrane or fluidised bed in fluidised-bed reactors. Another application of the mouldings described here is catalysis; the mouldings according to the invention can serve as supports for catalysts. Use in chromatography as stationary phase also belongs to the possible uses according to the invention. Biological and chemical sensors can also be produced using the mouldings having regularly arranged cavities which are obtainable in accordance with the invention if the pores are provided, by suitable surface treatment, with corresponding functional constituents, such as detection reagents, antibodies, enzyme substrates, DNA or RNA sequences or proteins.

With respect to the convertibility of the core/shell particles into inverse opal structures, it is preferred for the core:shell weight ratio to be in the range from 5:1 to 1:10, in particular in the range from 2:1 to 1:5 and particularly preferably in the range from 1.5:1 to 1:2.

The core/shell particles which can be used in accordance with the invention can be produced by various processes.

A preferred way of obtaining the particles is a process for the production of core/shell particles by a) surface treatment of monodisperse cores, and b) application of the shell of organic polymers to the treated cores.

In a preferred process variant, a crosslinked polymeric interlayer, which preferably contains reactive centres to which the shell can be covalently bonded, is applied to the cores, preferably by emulsion polymerisation or by ATR polymerisation. ATR polymerisation here stands for atom transfer radical polymerisation, as described, for example, in K. Matyjaszewski, Practical Atom Transfer Radical Polymerisation, Polym. Mater. Sci. Eng. 2001, 84. The encapsulation of inorganic materials by means of ATRP is described, for example, in T. Werne, T. E. Patten, Atom Transfer Radical Polymerisation from Nanoparticles: A Tool for the Preparation of Well-Defined Hybrid Nanostructures and for Understanding the Chemistry of Controlled/“Living” Radical Polymerisation from Surfaces, J. Am. Chem. Soc. 2001, 123, 7497-7505 and WO 00/11043. The performance both of this method and of emulsion polymerisations is familiar to the person skilled in the art of polymer preparation and is described, for example, in the above-mentioned literature references.

The liquid reaction medium in which the polymerisations or copolymerisations can be carried out consists of the solvents, dispersion media or diluents usually employed in polymerisations, in particular in emulsion polymerisation processes. The choice here is made in such a way that the emulsifiers employed for homogenisation of the core particles and shell precursors are able to develop adequate efficacy. Suitable liquid reaction media for carrying out the process according to the invention are aqueous media, in particular water.

Suitable for initiation of the polymerisation are, for example, polymerisation initiators which decompose either thermally or photochemically, form free radicals and thus initiate the polymerisation. Preferred thermally activatable polymerisation initiators here are those which decompose at between 20 and 180° C., in particular at between 20 and 80° C. Particularly preferred polymerisation initiators are peroxides, such as dibenzoyl peroxide, di-tert-butyl peroxide, peresters, percarbonates, perketals, hydroperoxides, but also inorganic peroxides, such as H₂O₂, salts of peroxosulfuric acid and peroxodisulfuric acid, azo compounds, alkylboron compounds, and hydro-carbons which decompose homolytically. The initiators and/or photoinitiators, which, depending on the requirements of the polymerised material, are employed in amounts of between 0.01 and 15% by weight, based on the polymerisable components, can be used individually or, in order to utilise advantageous synergistic effects, in combination with one another. In addition, use is made of redox systems, such as, for example, salts of peroxodisulfuric acid and peroxosulfuric acid in combination with low-valency sulfur compounds, particularly ammonium peroxodisulfate in combination with sodium dithionite.

Corresponding processes have also been described for the production of polycondensation products. Thus, it is possible for the starting materials for the production of polycondensation products to be dispersed in inert liquids and condensed, preferably with removal of low-molecular-weight reaction products, such as water or—for example on use of di(lower alkyl) dicarboxylates for the preparation of polyesters or polyamides—lower alkanols.

Polyaddition products are obtained analogously by reaction of compounds which contain at least two, preferably three, reactive groups, such as, for example, epoxide, cyanate, isocyanate or isothiocyanate groups, with compounds carrying complementary reactive groups. Thus, isocyanates react, for example, with alcohols to give urethanes and with amines to give urea derivatives, while epoxides react with these complementary groups to give hydroxyethers and hydroxyamines respectively. Like the polycondensations, polyaddition reactions can also advantageously be carried out in an inert solvent or dispersion medium.

The stable dispersions required for these polymerisation, polycondensation or polyaddition processes are generally prepared using dispersion auxiliaries.

The dispersion auxiliaries used are preferably water-soluble, high-molecular-weight organic compounds containing polar groups, such as polyvinylpyrrolidone, copolymers of vinyl propionate or acetate and vinylpyrrolidone, partially saponified copolymers of an acrylate and acrylonitrile, polyvinyl alcohols having different residual acetate contents, cellulose ethers, gelatin, block copolymers, modified starch, low-molecular-weight polymers containing carboxyl and/or sulfonyl groups, or mixtures of these substances.

Particularly preferred protective colloids are polyvinyl alcohols having a residual acetate content of less than 35 mol %, in particular from 5 to 39 mol %, and/or vinylpyrrolidone-vinyl propionate copolymers having a vinyl ester content of less than 35% by weight, in particular from 5 to 30% by weight.

It is possible to use nonionic or ionic emulsifiers, if desired also as a mixture. Preferred emulsifiers are optionally ethoxylated or propoxylated, relatively long-chain alkanols or alkylphenols having different degrees of ethoxylation or propoxylation (for example adducts with from 0 to 50 mol of alkylene oxide) or neutralised, sulfated, sulfonated or phosphated derivatives thereof. Neutralised dialkylsulfosuccinic acid esters or alkyldiphenyl oxide disulfonates are also particularly suitable.

Particularly advantageous are combinations of these emulsifiers with the above-mentioned protective colloids, since particularly finely divided dispersions are obtained therewith.

Through the setting of the reaction conditions, such as temperature, pressure, reaction duration and use of suitable catalyst systems, which influence the degree of polymerisation in a known manner, and the choice of the monomers employed for their preparation—in terms of type and proportion—the desired property combinations of the requisite polymers can be set specifically. The particle size here can be set, for example, through the choice and amount of the initiators and other parameters, such as the reaction temperature. The corresponding setting of these parameters presents the person skilled in the art in the area of polymerisation with absolutely no difficulties.

It is likewise preferred in accordance with the invention for the application of the shell of organic polymers to be carried out by grafting, preferably by emulsion polymerisation or ATR polymerisation. The methods and monomers described above can be employed correspondingly here.

The following examples are intended to explain the invention in greater detail without limiting it.

### EXAMPLES

Production of the Core/shell Latices PMMA-PSAN₅₀ (Shell Comprising 50% by Weight of Styrene and 50% by Weight of Acrylonitrile)

30 mg of sodium dithionite (SDTH, MERCK), dissolved in 5 g of water, are admixed with an initially introduced emulsion, held at 4° C., consisting of 217 g of water, 0.4 g of allyl methacrylate (ALMA, MERCK), 3.6 g of methyl methacrylate (MMA, MERCK) and 20.5 mg of sodium dodecylsulfate (SDS, MERCK).

The emulsion is transferred into a 1 l jacketed stirred reactor, held at 75° C., fitted with reflux condenser, argon gas inlet and double-propeller stirrer. Immediately after introduction of the emulsion, the reaction is initiated by addition of 150 mg of ammonium peroxodisulfate (APS, MERCK) and a further 30 mg of sodium dithionite (SDTH, MERCK), each dissolved in 5 g of water.

After 20 minutes, a monomer emulsion consisting of 9.6 g of ALMA (MERCK), 96 g of MMA (MERCK), 0.35 g of SDS (MERCK), 0.1 g of KOH (MERCK) and 130 g of water is metered in continuously via a rotating piston pump over a period of 120 minutes.

The reactor contents are stirred for 60 minutes without further addition. 100 mg of APS (MERCK), dissolved in 5 g of water, are then added. After stirring for a further 10 minutes, a second monomer emulsion consisting of 60 g of styrene (MERCK), 60 g of acrylonitrile, 0.33 g of SDS (MERCK) and 120 g of water is metered in continuously via a rotating piston pump over a period of 160 minutes.

In order to react the monomers virtually completely, the mixture is subsequently stirred for a further 60 minutes.

The core/shell particles are subsequently coagulated in 1 l of methanol, the precipitation is completed by addition of 25 g of concentrated aqueous sodium chloride solution, 1 l of distilled water is added to the suspension, the mixture is filtered through a suction filter, and the polymeric coagulate is dried at 50° C. under reduced pressure.

A mean particle size of the particles of 263 nm is determined with the aid of a transmission electron microscope.

Production of the Core/shell Latices PMMA-PSAN₇₀ (Shell Comprising 30% by Weight of Styrene and 70% by Weight of Acrylonitrile)

Recipe see above, with the following differences: The initially introduced emulsion comprises 22 mg of SDS (MERCK), the second monomer emulsion consists of 36 g of styrene (MERCK), 84 g of acrylonitrile, 120 g of water, 0.4 g of SDS (MERCK) and 0.34 g of Triton X405™.

Further Processing of the Coagulate to Give Films

The coagulate, consisting of PMMA-PSAN₅₀ latex particles, is converted in a DSM microextruder at 220° C. in a nitrogen atmosphere into a polymer extrudate, which is cut to give pellets with a length of 5 mm. The pellets are pressed to give films.

The pressing of in each case 1-2 g of coagulate or pellets to give films is carried out under the following conditions in a Collin 300 P laboratory press:
prewarming for 5 minutes at 180° C., without pressure;
pressing for 3 minutes at 1 bar at 180° C.;
pressing for 3 minutes at 150 bar at 180° C.;
slow cooling for 10 minutes at 150 bar, with about 90° C. being reached;
rapid cooling to room temperature, without pressure.

The films obtained have a thickness of about 0.2 mm, have an angle-dependent colour which is yellow-green when viewed perpendicularly, and are tough and resilient.

Pyrolysis of the Films

Variant a:

The films are pyrolysed for 5 hours at 240° C. in an air atmosphere in a muffle furnace.

The pyrolysed films have a black basic colour on which a violet reflection colour is superimposed when viewed perpendicularly. The latter is caused by an inverse opaline structure of the films, which can be seen in FIG. 1. The pores in the film have a somewhat elliptical shape, as can be seen in FIG. 1.

Variant b:

The films are conditioned for 2 weeks at 200° C. in an air atmosphere. The conditioned films, in which the polymer cores are still present, have a brown basic colour on which a green reflection colour is superimposed when viewed perpendicularly.

The films are subsequently pyrolysed for 5 hours at 240° C. in an air atmosphere in a muffle furnace.

The pyrolysed films have a black basic colour on which a violet reflection colour is superimposed when viewed perpendicularly. The pores in the film have a virtually spherical shape.

Index of Figures

FIG. 1:

Transmission electron photomicrograph of elliptical cavities of a PMMA-PSAN₇₀ film pyrolysed at 240° C. for a period of 5 hours.

1. Use of core/shell particles whose shell forms a matrix and whose core essentially consists of a degradable polymer and has an essentially monodisperse size distribution and whose shell can be pyrolysed to give a carbon matrix, for the production of mouldings having regularly arranged cavities.

2. Use according to claim 1, characterised in that the core consists of a material which is either not flowable or becomes flowable at a temperature above the melting point of the shell material.

3. Use according to claim 1, characterised in that the core:shell weight ratio in the core/shell particles is in the range from 5:1 to 1:10, in particular in the range from 2:1 to 1:5 and particularly preferably in the range from 1.5:1 to 1:2.

4. Use according to claim 1, characterised in that the shell in the core/shell particles consists of essentially uncrosslinked organic polymers which are grafted onto the core via an at least partially crosslinked interlayer, where the shell is preferably formed essentially from polyacrylonitrile (PAN) or copolymers containing polyacrylonitrile, such as polystyrene-acrylonitrile (PSAN).

5. Use according to claim 1, characterised in that the core in the core/shell particles is built up essentially from poly(styrene) and derivatives, such as poly(a-methylstyrene) or poly(styrene) derivatives carrying substituents on the aromatic ring, such as, in particular, partially or perfluorinated derivatives, poly-(acrylate) and poly(methacrylate) derivatives as well as esters thereof, particularly preferably poly(methyl methacrylate), poly(tert-butyl methacrylate), poly(methyl methacrylate), poly(n-butyl methacrylate) or poly(cyclohexyl methacrylate), or copolymers of these polymers with other degradable polymers, such as, preferably, styrene-ethyl acrylate copolymers or methyl methacrylate-ethyl acrylate copolymers, and polyolefins, polyolefin oxides, polyethylene terephthalate, polyformaldehyde, polyamides, polyvinyl acetate, polyvinyl chloride, polyvinyl alcohol or copolymers of these polymers.

6. Use according to claim 1, characterised in that the core/shell particles have a mean particle diameter in the range about 50-800 nm, preferably in the range 100-600 nm and particularly preferably in the range from 200 to 450 nm.

7. Use according to claim 1, characterised in that the mouldings are films.

8. Process for the production of mouldings having regularly arranged cavities, characterised in that core/shell particles whose shell forms a matrix and whose core essentially consists of a degradable polymer and has an essentially monodisperse size distribution and whose shell can be pyrolysed to give a carbon matrix are converted into mouldings (templates), preferably films, with application of a mechanical force and elevated temperature, and the cores are subsequently removed by degradation at elevated temperature and at the same time the shell is decomposed to give a carbon matrix.

9. Process according to claim 8, characterised in that a mechanical force is applied through uniaxial pressing or during an injection-moulding operation or during a transfer-moulding operation or during (co)extrusion or during a calendering operation or during a blowing operation.

10. Process according to claim 8, characterised in that the cores are removed by thermal degradation, preferably with exposure to air at temperatures of at least 150° C., preferably at least 200° C. and particularly preferably at least 220° C.

11. Process according to claim 8, characterised in that the cores are removed by degradation by means of UV radiation.

12. Process according to claim 1, characterised in that the matrix is pre-condensed in a first step, and the cores are only removed in a second, subsequent step.

13. Process according to claim 8, characterised in that the cores are removed before or at the same time as the condensation of the matrix.

14. Process according to claim 1, characterised in that the carbon matrix is produced at temperatures in the range from 700 to 1200° C., preferably in the range from 800 to 1000° C., with exclusion of air.

15. Mouldings having regularly arranged cavities which are embedded in a carbon matrix, characterised in that the mouldings are obtainable by a process in which core/shell particles whose shell forms a matrix and whose core essentially consists of a degradable polymer and has an essentially monodisperse size distribution and whose shell can be pyrolysed to give a carbon matrix are converted into mouldings (templates), preferably films, with application of a mechanical force and elevated temperature, and the cores are subsequently removed by thermal degradation at elevated temperature and at the same time the shell is decomposed to give a carbon matrix.

16. Mouldings having regularly arranged cavities which are embedded in a carbon matrix, characterised in that the mouldings have directed ellipsoidal cavities.

17. Mouldings according to claim 15, characterised in that the cavities have a mean diameter in the range about 50-500 nm, preferably in the range 100-500 nm and very particularly preferably in the range from 200 to 280 nm.

18. Use of mouldings according to claim 15 as photonic material.

19. Use of mouldings according to claim 15 for the production of electro-optical devices.

20. Electro-optical device containing mouldings produced in accordance with claim 8.
